(19) United States
(12) Patent Application Publication
(10) Pub. No.: US 2008/0011467 A1
(43) Pub. Date: Jan. 17, 2008

(54) Method, apparatus and system for thermal management using power density feedback

(75) Inventors: Rafael Rodarte, McFarland, CA (US); Jim Hermerding, San Jose, CA (US); Ishmael Santos, Milpitas, CA (US)

Correspondence Address: INTEL CORPORATION;c/o INTELLEVATE, LLC, P.O. BOX 52050, MINNEAPOLIS, MN, 55402, US

(73) Assignee: INTEL CORPORATION

(21) Appl. No.: 11/474,023

(22) Filed: Jun. 23, 2006

(51) Int. Cl. G05D 23/00

(52) U.S. Cl. 165/287

(57) ABSTRACT

A method and system are described for thermal management using power density feedback. The system may include one or more regions of the system, where the system includes one or more dies; and a thermal relationship coefficient to describe a thermal relationship between the one or more regions. In some embodiments, the embodiments of the method may include measuring the activity of one or more regions, and using the thermal relationships to determine an activity configuration for the system or parts thereof. In some embodiments, the activity configuration may be applied to the one or more regions. Other embodiments may be described.

### BACKGROUND

1. Technical Field

Some embodiments of the present invention generally relate to computer systems, and more specifically, some embodiments may relate to system thermal management.

2. Discussion

As microprocessors and other components within a computer system become faster and smaller, thermal management becomes more important to prevent device overheating or failure. In some systems, if an overheated device, such as a processor, is detected, then the activity level of the system or device may be adjusted, such as by reducing the operating speed of the processor. However, this approach to thermal management considers only the temperature of the device itself, and does not take into consideration thermal coupling or power density in the system.

### BRIEF DESCRIPTION OF THE DRAWINGS

Various advantages of embodiments of the present invention will become apparent to one of ordinary skill in the art by reading the following specification and appended claims, and by referencing the following drawings, in which:

FIGS. 1 and 2 are flowcharts of the process for thermal management using power density feedback according to some embodiments of the system;

FIG. 3 is an illustration of examples of density factor change and thermal relationship coefficient calculations according to some embodiments of the invention;

FIG. 4 is an illustration of examples of thermal relationship tables according to some embodiments of the invention;

FIG. 5 is an illustration of examples of a power distribution register according to some embodiments of the invention; and

FIG. 6 includes a schematic diagram of a computer system according to some embodiments of the invention.

### DETAILED DESCRIPTION OF SOME EMBODIMENTS

Reference is made to some embodiments of the invention, examples of which are illustrated in the accompanying drawings. While the present invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims. Moreover, in the following detailed description of the invention, numerous specific details are set forth in order to provide a thorough understanding of the invention. However, the invention may be practiced without these specific details. In other instances, well-known methods, procedures, components and circuits have not been described in detail as not to unnecessarily obscure aspects of the invention.

Reference in the specification to “one embodiment” or “some embodiments” of the invention means that a particular feature, structure or characteristic described in connection with the embodiment is included in at least some embodiments of the invention. Thus, the appearances of the phrase “in some embodiments” or “according to some embodiments” appearing in various places throughout the specification are not necessarily all referring to the same embodiment.

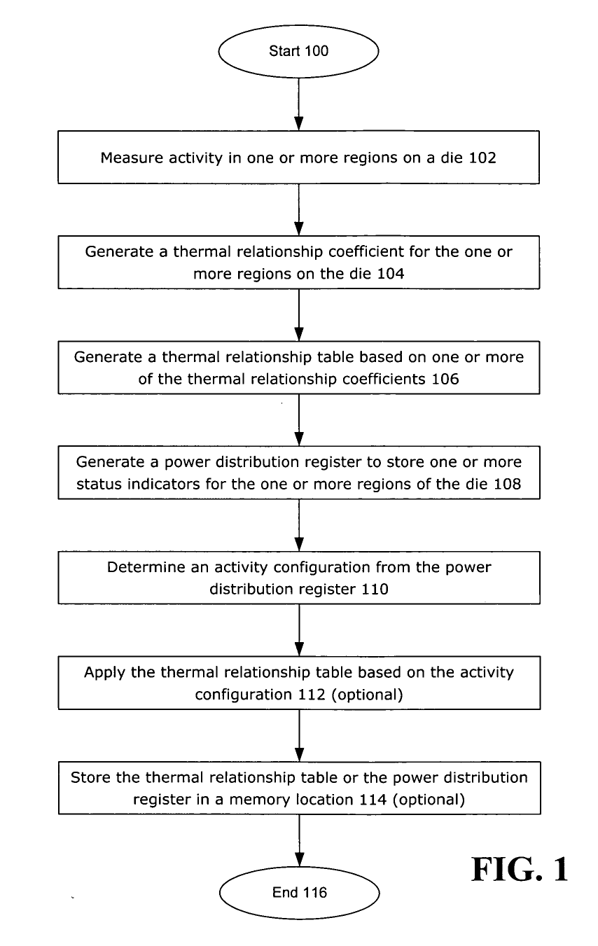

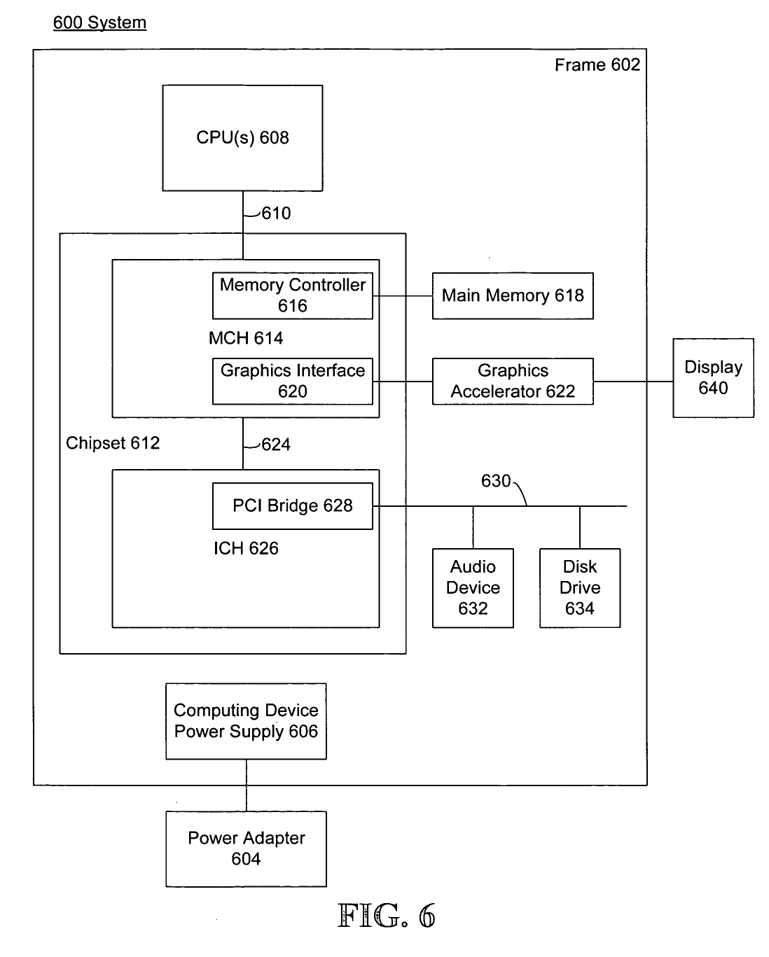

According to some embodiments, the method may be implemented within a computing system. The system described with respect to FIG. 6, below, may be used to perform the operations described herein with respect to FIGS. 1-5, as one of ordinary skill in the relevant arts would appreciate based at least on the teachings provided herein.

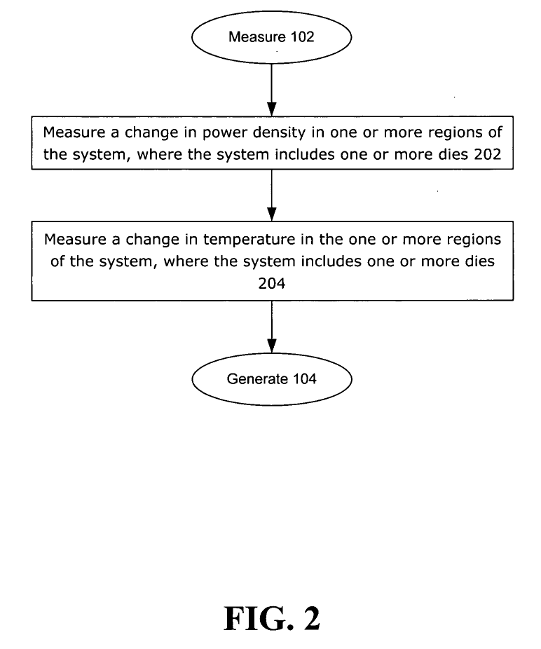

FIGS. 1 and 2 are flowcharts of the process for thermal management using power density feedback according to some embodiments of the system. In some embodiments, the method or process of FIG. 1 may start at 100 and proceed to 102, where the operation may measure activity in one or more regions of a system, where the system may include one or more dies. In some embodiments, the one or more regions may include, as part of all of a system, a microprocessor, a memory controller hub, an input/output controller hub, a memory, a core, a chipset, a graphics memory controller hub, or other components. Moreover, in some embodiments, there may be more than one die utilized in the embodiments of the invention.

In some embodiments, as illustrated in FIG. 2, the measuring of activity may also include measuring a change in power density in the one or more regions on a die (202) and/or measuring a change in temperature in the one or more regions of a system (204). In some embodiments, the system may include one or more dies. Furthermore, in some embodiments, the measuring activity may include measuring current changes or voltage changes in the one or more regions.

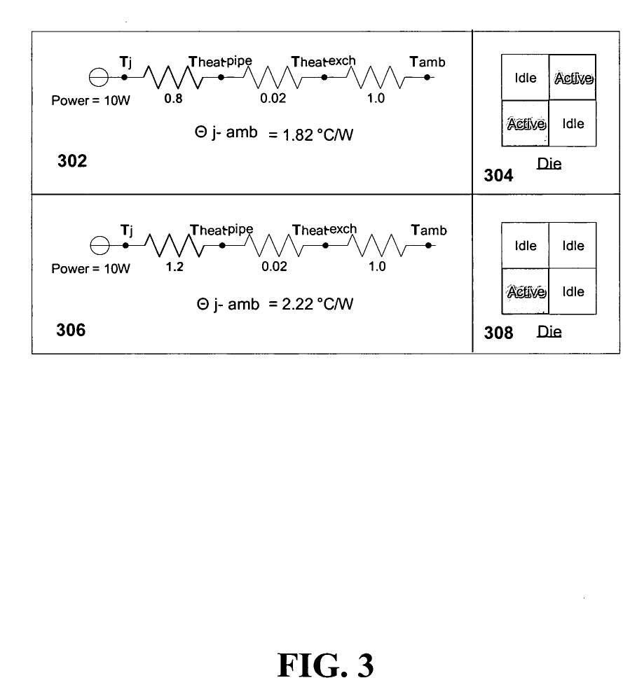

The process may then proceed to 104, where it may generate a thermal relationship coefficient (TRC) for the one or more regions, where the TRC may be based on at least the measured activity. Examples of TRCs are illustrated in FIG. 3 and described elsewhere herein. In some embodiments, the TRC may be based on one or more power states, voltage differences, power differences and/or current differences. In some embodiments, the one or more power states may include at least one or an active state or a sleep state.

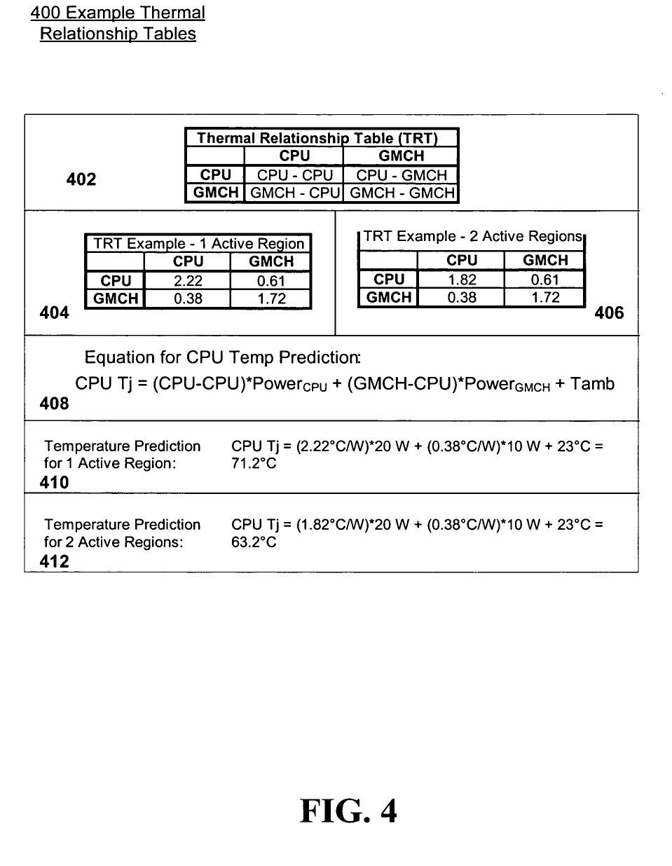

The process may then proceed to 106, where it may generate a thermal relationship table (TRT) based on one or more of the TRCs. Examples of TRTs are illustrated in FIG. 4 and described elsewhere herein. In some embodiments, the TRT may provide one or more relationships between the one or more regions, where the one or more relationships may be used to predict temperature distributions in the one or more regions. Moreover, the one or more relationships may include information that allow for calculation of the amount or level of power change required to achieve a given temperature change in the one or more regions.

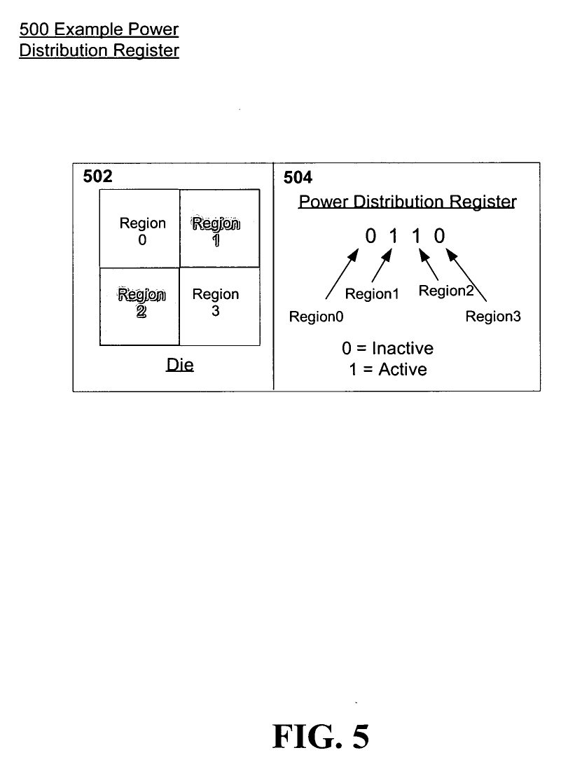

The process may then proceed to 108, where it may generate a power distribution register (PDR) to track one or more status indicators for the one or more regions. Examples of PDRs are illustrated in FIG. 5 and described elsewhere herein. In some embodiments, the one or more status indicators may include information about whether the one or more regions are active or inactive, or in another power state or activity level.

The process may then proceed to 110, where it may determine an activity configuration from the PDR, where the activity configuration may include at least a workload condition appropriate to the activity in the one or more regions. In some embodiments, the activity configuration may be matched to a configuration measured by one or more TRCs and stored in a TRT. In some embodiments, the workload condition may include changes to the power or activity levels of components in the one or more regions of the system, where the system may include one or more dies.

The process may then proceed to 112, where it may apply the TRT based on the activity configuration. In some embodiments, the process at 112 may include increasing heat dissipation to the one or more regions, or decreasing activity of the one or more regions.

The process, in some embodiments, may then proceed to 114, where it may store the TRT or the PDR in a memory location. In some embodiments, the memory location may be a system memory, a cache memory, a disk drive, or a main memory.

FIG. 3 is an illustration of examples 300 of density factor change and TRC calculations according to some embodiments of the invention. The examples, in some embodiments, may illustrate how a change in power density can have an impact on the thermal behavior of a component. In some embodiments, the circuits in 302 and 306 show a system 304 or die 304, based on some embodiments of the invention, with two active regions that may be consuming power and a system 308 or die 308 with one active region that may be consuming power. In some embodiments, the active regions may be consuming more power relative to the inactive regions, while the inactive regions may still consume power.

In some embodiments, the total power being used on the systems or dies 304 and 308 may be the same. The calculations in 302 and 206 may illustrate that the change in power distribution may have an impact in the junction-heat pipe resistance of the component and an overall impact on the junction-ambient resistance. These changes may require a determination of TRCs that are specific to each scenario or activity configuration. As such, in some embodiments, a TRC may be calculated for each configuration, as shown in the examples 302 and 306 by the Theta(j-amb) [Θ_{j-amb}]. The different results in the TRC in each example are due to at least the differences in power density.

As described elsewhere herein, the ability to establish a thermal relationship, signified by the TRC, may be useful when more than one component or heat generating regions exist within thermal proximity to each other. In some embodiments, being aware of the thermal relationships between regions may allow a system to apply more appropriate workload conditions, as well as determine which regions have influence over the temperature of other regions, to solve or assist in resolving thermal issues.

For each TRC in a TRT, the system, such as system 600 described elsewhere herein, may have a thermal management policy that uses the information in the TRTs, among other things, to determine which region(s) should be thermally managed, as described above in some embodiments with respect to FIGS. 1-2. In some embodiments, the thermal management policy may include implementation of Advanced Configuration and Power Interface (ACPI) information, in accordance with the ACPI Specification, Revision 3.0, published Sep. 2, 2004.

FIG. 4 is an illustration of examples 400 of thermal relationship tables according to some embodiments of the invention. The examples 402, 404, and 406 may describe structures of TRTs, as well as how the TRCs in the TRTs may be used to predict at least the temperature of components, according to some embodiments. The units of the coefficients in the tables are in ° C./W, but are not limited to these units, as one of ordinary skill in the relevant art would appreciate based at least on the teachings described herein. Example 402 may illustrate a format, where two regions of a die, CPU and GMCH, and may be read in the following manner:

CPU-CPU=Temperature change of CPU for every Watt change in CPU Power;

GMCH-CPU=Temperature change of CPU for every Watt change in GMCH Power;

GMCH-GMCH=Temperature change of GMCH for every Watt change in GMCH Power; and

CPU-GMCH=Temperature change of GMCH for every Watt change in CPU Power.

The example 402 may show, in some embodiments, that there may be potentially two different tables that mat be used to describe the relationship between the CPU and GMCH or other regions. In some embodiments, depending upon how the power is distributed on the die the CPU-CPU TRT coefficient may change. This change in coefficient may impact that temperature prediction made by the process in embodiments of the invention. With respect to the examples shown in 408, 410, and 412, which correspond respectively to 402, 404, and 406, the examples have a system that is reporting 20 W of power on the CPU and 10 W of power on the GMCH. The corresponding TRCs and resultant temperature calculations, as shown in 410 and 412, may provide a more accurate prediction of temperature as the thermally adjacent regions are being considered.

FIG. 5 is an illustration of examples of a power distribution register 500 according to some embodiments of the invention. The example 504 describes one of several approaches that may be used to assess how power is being distributed on a particular die, system, or component. In some embodiments, the PDR may have bits assigned to indicate the status of regions on the die and whether they are active or not, according to some embodiments of the invention. The example 504 shows a system or die with four regions. In some embodiments, with four regions, the PDR may be implemented with four bits in a register. In some embodiments, each bit would be assigned to a specific region; and a “0” may indicate that the region is inactive and/or does not have one or more utilization rates. In some embodiments, a value of “1” may indicate an active region with one or more utilization rate. In some embodiments of the invention, the PDR could be polled by the system, such as system 600 described elsewhere herein. As such, in some embodiments, the value from the PDR and/or an overall component power reading may provide enough information to apply an appropriate TRT that would provide an appropriate the workload condition.

FIG. 6 includes a schematic diagram of a computer system according to some embodiments of the invention. The computer system 600 includes a frame (or computing device) 602 and a power adapter 604 (e.g., to supply electrical power to the computing device 602). The computing device 602 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 602 (e.g., through a computing device power supply 606) from one or more of the following sources: One or more battery packs, an alternating current (AC) outlet (e.g., through a transformer and/or adaptor such as a power adapter 604), automotive power supplies, airplane power supplies, and the like. In some embodiments, the power adapter 604 may transform the power supply source output (e.g., the AC outlet voltage of about 110VAC to 240VAC) to a direct current (DC) voltage ranging between about 7VDC to 12.6VDC. Accordingly, the power adapter 604 may be an AC/DC adapter.

The computing device 602 may also include one or more central processing unit(s) (CPUS) 608 coupled to a bus 610. In some embodiments, the CPU 608 may be one or more processors in the Pentium® family of processors including the Pentium® II processor family, Pentium® III processors, Pentium® IV processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multiple core design.

A chipset 612 may be coupled to the bus 610. The chipset 612 may include a memory control hub (MCH) 614. The MCH 614 may include a memory controller 616 that is coupled to a main system memory 618. The main system memory 618 stores data and sequences of instructions that are executed by the CPU 608, or any other device included in the system 600. In some embodiments, the main system memory 618 includes random access memory (RAM); however, the main system memory 618 may be implemented using other memory types such as dynamic RAM (DRAM), synchronous DRAM (SDRAM), and the like. Additional devices may also be coupled to the bus 610, such as multiple CPUs and/or multiple system memories.

The MCH 614 may also include a graphics interface 620 coupled to a graphics accelerator 622. In some embodiments, the graphics interface 620 is coupled to the graphics accelerator 622 via an accelerated graphics port (AGP). In an embodiment, a display (such as a flat panel display) 640 may be coupled to the graphics interface 620 through, for example, a signal converter that translates a digital representation of an image stored in a storage device such as video memory or system memory into display signals that are interpreted and displayed by the display. The display 640 signals produced by the display device may pass through various control devices before being interpreted by and subsequently displayed on the display.

A hub interface 624 couples the MCH 614 to an input/output control hub (ICH) 626. The ICH 626 provides an interface to input/output (I/O) devices coupled to the computer system 600. The ICH 626 may be coupled to a peripheral component interconnect (PCI) bus. Hence, the ICH 626 includes a PCI bridge 628 that provides an interface to a PCI bus 630. The PCI Bridge 628 provides a data path between the CPU 608 and peripheral devices. Additionally, other types of I/O interconnect topologies may be utilized such as the PCI Express™ architecture, available through Intel® Corporation of Santa Clara, Calif.

The PCI bus 630 may be coupled to an audio device 632 and one or more disk drive(s) 634. Other devices may be coupled to the PCI bus 630. In addition, the CPU 608 and the MCH 614 may be combined to form a single chip. Furthermore, the graphics accelerator 622 may be included within the MCH 614 in other embodiments. As yet another alternative, the MCH 614 and ICH 626 may be integrated into a single component, along with a graphics interface 620.

Additionally, other peripherals coupled to the ICH 626 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 602 may include volatile and/or nonvolatile memory.

As may be evident from the system 600 and the embodiments described with respect to FIGS. 1-5, some embodiments of the invention may be implemented in a system 600. The system 600 may include one or more regions on a die, where each of the one or more regions may have a thermal relationship with other regions of the die. The one or more regions may be within the frame 602, on the chipset 612, the MCH 614, ICH 626, graphics accelerator 622, or other component, as one of ordinary skill in the relevant art would appreciate may be implemented on the same die or chip as other components of the system 600. Furthermore, the system 600 may include a thermal relationship coefficient (TRC), described elsewhere herein with respect to FIG. 3 in embodiments, to describe the thermal relationship between the one or more regions of the die. In some embodiments, one or more TRCs may be implemented in a main memory 618 or other memory or storage device, within other components of the system 600, as one of ordinary skill in the relevant art would appreciate based at least on the teachings provided herein.

In some embodiments, a thermal relationship table (TRT) may be generated from the TRCs. As described in some embodiments, the TRT may include at least a comparison of each of the TRCs for each of the one or more regions. In some embodiments, a power distribution register (PDR) may also be generated to track one or more status indicators, where the status indicators include information as to whether a region is active or inactive or in another state. Furthermore, in some embodiments, the PDR is capable of thermally managing the system by tracking activity in the one or more regions.

The system 600 may be capable of utilizing the TRC, TRT, and/or PDR, such as those described above in FIGS. 3-5, to determine which of the one or more regions may require thermal management. In some embodiments, thermal management may involve altering the power state of the region or die or system. In some embodiments, thermal management may include increasing the cooling effort in one or more regions of the die or system. As such, as one of ordinary skill in the relevant arts would appreciate based at least on the teachings described herein, the embodiments of the invention may be implemented in one or more regions on a die, where the one or more regions include the microprocessor 608 or in a multiple processor environment, one or more cores, the MCH 614 or its sub-components 616 or 620, the ICH 626 or its sub-components 628, the main memory 618, the chipset 612, the graphics memory controller hub (GMCH) 620 or 622, or another component or components.

In some embodiments, the frame or computing device 602 may include more than one die, as one of ordinary skill in the relevant arts would appreciate based at least on the teachings described herein. The embodiments of the invention may be practiced in systems with more than one die; thus, the one or more regions may be on more than one die, and references to “on a die” are includes to “on one or more dies,” as one of ordinary skill in the relevant arts would appreciate based at least on the teachings described herein.

Embodiments of the invention may be described in sufficient detail to enable those skilled in the art to practice the invention. Other embodiments may be utilized, and structural, logical, and intellectual changes may be made without departing from the scope of the present invention. Moreover, it is to be understood that various embodiments of the invention, although different, are not necessarily mutually exclusive. For example, a particular feature, structure, or characteristic described in some embodiments may be included within other embodiments. Those skilled in the art can appreciate from the foregoing description that the techniques of the embodiments of the invention can be implemented in a variety of forms.

Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A system comprising:
one or more regions of the system, each of the one or more regions having a thermal relationship with other regions, wherein the system includes one or more dies; and
a thermal relationship coefficient to describe the thermal relationship between the one or more regions.

2. The system of claim 1, further comprising thermal relationship table and a power distribution register.

3. The system of claim 2, wherein the thermal relationship table comprises at least a comparison of each of the thermal relationship coefficients for each of the one or more regions.

4. The system of claim 2, wherein the power distribution register is capable of thermally managing the system by tracking activity in the one or more regions.

5. The system of claim 2, wherein the system is capable of utilizing the thermal relationship coefficient to determine which of the one or more regions require thermal management.

6. The system of claim 1, wherein the one or more regions include a microprocessor, a memory controller hub, an input/output controller hub, a memory, a core, a chipset, or a graphics memory controller hub.

7. A method comprising:
measuring activity in one or more regions of a system, wherein the system includes one or more dies;
generating a thermal relationship coefficient for the one or more regions, wherein the thermal relationship coefficient is based on at least the measured activity;
generating a thermal relationship table based on one or more of the thermal relationship coefficients;
generating a power distribution register to track one or more status indicators for the one or more regions; and
determining an activity configuration from the power distribution register, wherein the activity configuration includes at least a workload condition appropriate to the activity in the one or more regions.

8. The method of claim 7, further comprising:
applying the activity configuration based on the thermal relationship table.

9. The method of claim 7, where the measuring of activity further comprises:
measuring a change in power density in the one or more regions; and
measuring a change in temperature in the one or more regions.

10. The method of claim 7, wherein the measuring activity includes measuring current changes or voltage changes.

11. The method of claim 7, wherein the thermal relationship table provides one or more relationships between the one or more regions.

12. The method of claim 11, wherein the one or more relationships includes information predicting temperature distributions in the one or more regions.

13. The method of claim 11, wherein the one or more relationships includes information that allow for calculation of power reduction change to achieve a given temperature change in the one or more regions.

14. The method of claim 7, wherein the one or more status indicators includes information about whether the one or more regions are active.

15. The method of claim 7, wherein the one or more regions include a microprocessor, a memory controller hub, an input/output controller hub, a memory, a core, a chipset, or a graphics memory controller hub.

16. The method of claim 7, wherein the thermal relationship coefficient is based on one or more power states, wherein the one or more power states include at least one or an active state or a sleep state.

17. The method of claim 7, further comprising:
storing the thermal relationship table or the power distribution register in a memory location.

18. The method of claim 17, wherein the memory location is a system memory, cache memory, a disk drive, or a main memory.

19. The method of claim 8, wherein the applying of the activity configuration includes increasing heat dissipation to the one or more regions, or decreasing activity of the one or more regions.

20. A machine accessible medium to store a set of instructions that when executed, perform a method comprising:
measuring activity in one or more regions of a system, wherein the system includes one or more dies;
generating a thermal relationship coefficient for the one or more regions, wherein the thermal relationship coefficient is based on at least the measured activity;
generating a thermal relationship table based on one or more of the thermal relationship coefficients;
generating a power distribution register to track one or more status indicators for the one or more regions; and
determining an activity configuration from the power distribution register, wherein the activity configuration includes at least a workload condition appropriate to the activity in the one or more regions.

21. The machine accessible medium of claim 20, further comprising:
applying the activity configuration based on the thermal relationship table.

22. The machine accessible medium of claim 20, where the measuring of activity further comprises:
measuring a change in power density in one or more regions; and
measuring a change in temperature in the one or more regions.

23. The machine accessible medium of claim 20, wherein the measuring activity includes measuring current changes or voltage changes.

24. The machine accessible medium of claim 20, wherein the thermal relationship table provides one or more relationships between the one or more regions.

25. The machine accessible medium of claim 24, wherein the one or more relationships includes information predicting temperature distributions in the one or more regions.

26. The machine accessible medium of claim 24, wherein the one or more relationships includes information that allow for the calculation of the power reduction required to achieve a given temperature reduction in the one or more regions.

27. The machine accessible medium of claim 20, wherein the one or more status indicators includes information about whether the one or more regions are active.

28. The machine accessible medium of claim 20, wherein the one or more regions include a microprocessor, a memory controller hub, an input/output controller hub, a memory, a core, a chipset, or a graphics memory controller hub.

29. The machine accessible medium of claim 20, wherein the thermal relationship coefficient is based on one or more power states, wherein the one or more power states include at least one or an active state or a sleep state.

30. The machine accessible medium of claim 20, further comprising:
storing the thermal relationship table or the power distribution register in a memory location.

31. The machine accessible medium of claim 30, wherein the memory location is a system memory, cache memory, a disk drive, or a main memory.

32. The machine accessible medium of claim 21, wherein the applying of the activity configuration includes increasing the cooling to the one or more regions, or decreasing the activity of the one or more regions.
